(19) United States
(12) Patent Application Publication
(10) Pub. No.: US 2013/0084382 A1
(43) Pub. Date: Apr. 4, 2013

(54) EXTRUDED CABLE STRUCTURES AND SYSTEMS AND METHODS FOR MAKING THE SAME

(71) Applicants: John B. Ardisana, II, San Francisco, CA (US); Edward Siahaan, San Francisco, CA (US); Albert Golko, Saratoga, CA (US)

(72) Inventors: John B. Ardisana, II, San Francisco, CA (US); Edward Siahaan, San Francisco, CA (US); Albert Golko, Saratoga, CA (US)

(73) Assignee: APPLE INC., Cupertino, CA (US)

(21) Appl. No.: 13/250,859

(22) Filed: Sep. 30, 2011

(51) Int. Cl. B05D 5/12

(52) U.S. Cl. 427/117

(57) ABSTRACT

Cable structures can be formed for cables and other components that include non-cable components such as jacks and headphones. The cable structure includes an outer jacket that is formed from a silicon polymer-based material that is extruded to form a jacket that completely encapsulates a conductive bundle. The cable structures utilizing silicon polymer-based materials can be simple two-ended cables or they can include several legs connected at a point of bifurcation. The extrusion process can be used to manufacture the multiple legs even if they are to be formed of different dimensions. As the silicon polymer-based material is processed by an extruder, one or more system factors of the extruder can be dynamically adjusted to change the diameter of the resulting leg (e.g., to provide a smooth leg having a changing size).

### BACKGROUND

The ever increasing use of portable electronic devices, such as portable music players and mobile phones, has led to the wide spread use of data cables that users utilize for a variety of purposes. A large majority of those cables are manufactured using thermoplastic (TPE) or thermoplastic polyurethane (TPU) elastomers for the cable jacket material. Those cables provide a given level of performance with regard to abrasive wearing, etc. When manufacturing cables in this manner, engineers generally follow a given set of design criteria that defines a minimum thickness for the cable for a given level of performance. Adding thickness to the cable in order to meet performance criteria, however, comes at the cost of reduced flexibility, which may also lead to premature failure due to the fact that the thicker the cable, the stiffer the cable. Moreover, the stiffer the cable, the more likely it is to fail if it is put under repeated stress through normal handling.

In addition to the flexibility/cable diameter issue, such cables are also often prone to other problems that can reduce the satisfaction experienced by the user. For example, TPE/TPU materials are often prone to chemical attacks that cause the materials to degrade over time (in some instances, the time is shorter than others). In many instances, individuals use their portable electronic devices while enjoying time outside (e.g., such as while running or sitting on the beach). Under those circumstances, many individuals use sunscreen to attempt to prevent sunburns and the other issues that can occur. Sunscreen, however, is one of many chemicals that can cause TPE/TPU elastomers to degrade and eventually break down. Thus, it is possible that, through normal regular use during a summer of sun, a pair of headphones made from TPE/TPU could fail due to exposure to sunscreen (or any of a number of other oils).

Another issue that may arise through the use of TPE/TPU jacket material is the fact that such materials stain easily. Thus, a user may quickly get to the point where they believe that their headphones and/or data transfer cables are “dirty and disgusting” even though the useful life of the cables themselves has not yet been reached.

The one or more cables can be manufactured using different approaches.

### SUMMARY

Extruded cable structures and systems and methods for manufacturing extruded cable structures are disclosed.

A cable structure can be utilized in many ways. In some instances, the cable structure can be as simple as a cable with a connector at each end. In other instances, such as a headset, the cable structure can be used to interconnect various non-cable components such as, for example, a plug, headphones, and/or a communications box to provide the completed headset. In some instances, the cable structure can include several legs (e.g., a main leg, a left leg, and a right leg) that each connect to a non-cable structure, and each leg may be connected to one another at a bifurcation region (e.g., a region where the main leg appears to split into the left and right legs). Cable structures according to some embodiments of this invention provide aesthetically pleasing cables that resist staining and damage from chemical attack, and that tend to be more flexible while maintaining their intended shape over a longer period of time.

The cable structures described herein, in accordance with the principles of the present invention, utilize silicon polymers in place of traditional cable jacket materials (e.g., TPE/TPU elastomers). The silicon polymers cause the cables to be more flexible, to maintain their intended shape for a longer periods of time, to be more prone to returning to their original shape even after significant bending and twisting by the user, and to be more resistant to the adverse effects of chemical attacks. Accordingly, cables made in accordance with these principles will be less likely to swell when exposed to, for example, sunscreen and other chemicals, as well as being less likely to stain. In addition, cables having a silicon polymer-based jacket tend to need smaller minimum thicknesses while achieving the same or better performance than jackets formed from other materials.

### BRIEF DESCRIPTION OF THE DRAWINGS

The above and other aspects and advantages of the invention will become more apparent upon consideration of the following detailed description, taken in conjunction with accompanying drawings, in which like reference characters refer to like parts throughout, and in which:

FIG. 1 shows an illustrative cross-sectional view of a cable structure constructed in accordance with some embodiments of the invention;

FIG. 2 is a cross-sectional view of an illustrative extruder in accordance with some embodiments of the invention; and

FIG. 3 is a flowchart of an illustrative process for extruding a cable structure in accordance with some embodiments of the invention.

### DETAILED DESCRIPTION OF THE DISCLOSURE

Cable structures for use with portable electronic devices are disclosed. The cable structures disclosed herein can be used for various purposes. For example, one could use these cable structures for data transfer cables that enable users to put content on, and extract content from, their portable electronic devices. In other instances, these cables structures may be used to manufacture headsets that can be used daily, regardless of the environmental conditions. For example, these cable structures can be used to interconnect various non-cable components to form a headset, such as, a plug, headphones, and/or a communications box to provide the headset. In many of these circumstances, users tend to desire cables that are aesthetically pleasing, and as such, have increasingly been white in color.

In addition, a common complaint that users often have is that their cables get all tangled up and become a mess. Once they have been bent and/or wound up (to be more compact for transit, for example), traditional cables tend to never return to their original shape to the dissatisfaction of the users. Cable jackets formed from TPE/TPU elastomers are often extruded which enable them to be manufactured at high volume. The conductors and any other materials (such as the mylar shielding material often found in cables) are assembled together and the jacket material is extruded to surround and encompass those materials to form the finished cable.

The use of silicon polymers, unlike TPE/TPU elastomers, is often accomplished through compression molding techniques. While those techniques can be utilized successfully in many instances, compression molding is too slow of a process to manufacture the miles and miles of cables that are needed to meet the ever-growing demands of society.

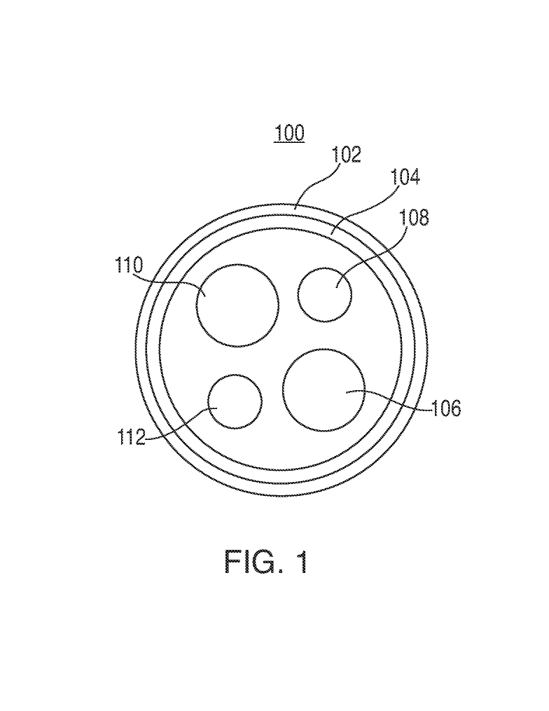

FIG. 1 shows an illustrative cross-sectional view of a cable structure in accordance with the principles of the present invention. Cable structure 100 includes outer jacket 102, mylar shield 104, and conductors 106, 108, 110 and 112. In the illustration shown in FIG. 1, cable 100 could, for example, be utilized as a USB cable, which requires four conductors for normal operations. Outer jacket 102, in this instance, is formed from silicon polymers instead of the traditional TPE/TPU elastomers. Moreover, the silicon polymer jacket is formed through an extrusion process, such that the necessary manufacturing rates can be maintained.

The use of plain silicon polymers, however, may tend to result in cables that can have additional failures. For example, silicon polymers tend not to be flame retardant. This particular feature, however, can be of critical importance with regard to electrical cables, since shorts, overloading and other issues could potentially cause the cable to degrade, or even catch on fire. Accordingly, in accordance with the principles disclosed herein, the silicon polymers used in the present invention need to have a flame retardant additive so that they can experience the same or better performance as traditional cables in this regard.

Accordingly, cable jacket 102 is formed from a combination of materials including one or more silicon polymers and a flame retardant. The cable jacket is formed through an extrusion process that results in cables that are pliable and flexible, but that also tend to have better memory effects than TPE/TPU based cable jackets. In that regard, silicon-based cable jackets tend to result in cables that will maintain a given elasticity such that they will return to a given shape even after they have been repeatedly bent and mangled.

Moreover, cable jackets formed from silicon polymers will be significantly more resistant chemical and heat damage. In this case, the broad use of portable electronic devices during the summer vacation months will not result in cable after cable being discarded for failure or for having become stained and dirty. An additional advantage is that the performance characteristics of the silicon-based polymers are comparable with TPE/TPU elastomer-based cable jackets that are significantly thicker than the silicon polymer counter parts.

As described above, the cable structures of the present invention can be constructed by extrusion. The extrusion process used can be selected such that varying types of cables can be formed. For example, silicon polymer-based extrusion can be used to for simple two-ended cables, or more complex cables having multiple ends feeding off of one or more joints. Under such circumstances, each of the individual regions, such as a taper region, a non-interface region, and a bifurcation region of each leg can be constructed seamlessly as part of the extrusion process. Moreover, each region of the leg can have a different diameter (e.g., a different cross-section), based on the particular extrusion process selected.

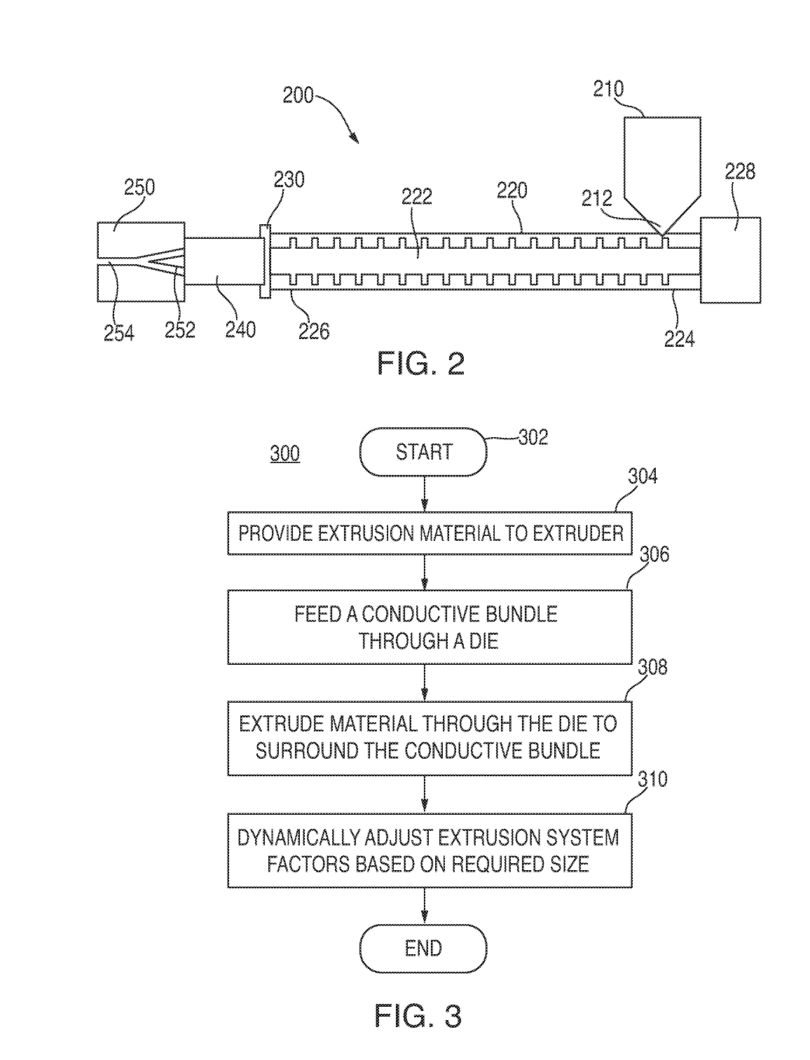

FIG. 2 is a cross-sectional view of an illustrative extruder in accordance with some embodiments of the invention. Extruder 200 can receive a material to extrude in a first form, such as pellets, and can transform the material to a form corresponding to cable structure 100.

While extruder 200 can extrude any suitable material to create cable structure 100, the cable structures of the present invention are directed toward the extrusion of silicon-based polymer cable jackets. Material can be provided to extruder 200 in any suitable form including, for example, in liquid or solid form. In one implementation, pellets or chips of material can be provided to hopper 210 for processing. The material can pass through feedthroat 212 and enter barrel 220. Screw 222 can rotate within barrel 220 to direct material from hopper end 224 of the barrel to die end 226 of the barrel. Drive motor 228 can be mechanically connected to screw 222 such that the screw can rotate to direct material received from hopper 210 towards die end 226. The drive motor can drive screw 222 at any suitable rate or speed, including a variable speed based on a manner in which the process is executed.

Barrel 220 can be heated to a desired melt temperature to melt the material provided in hopper 210. For example, barrel 220 can be heated to a temperature in the range of 200° C. to 300° C. (e.g., 250° C.), although the particular temperature can be selected based on the material used. As the material passes through barrel 220, pressure and friction created by screw 222, and heat applied to barrel 220 by a heating component can cause the material to melt and flow. The resulting material can be substantially liquid in a region near die end 226 of barrel 220 so that it may easily flow into die 250. In some cases, different amounts of heat can be applied to different sections of the barrel to create a variable heat profile. In one implementation, the amount of heat provided to barrel 220 can increase from hopper end 224 to die end 226. By gradually increasing the temperature of the barrel, the material deposited in barrel 220 can gradually heat up and melt as it is pushed toward die end 226. This may reduce the risk of overheating, which may cause the material to degrade. In some embodiments, extruder 200 can include cooling components (e.g., a fan) in addition to heating components for controlling a temperature profile of barrel 220.

In some cases, one or more additives can be added to the material within barrel 220 to provide mechanical or finishing attributes to cable structure 100. For example, components for providing flame retardation, modifying a coefficient of friction of an outer surface of cable structure 100, refining a color of cable structure 100, or combinations of these can be used. The additives can be provided in hopper 220, or alternatively can be inserted in barrel 220 at another position along the barrel length. The amount of additives added, and the particular position at which additives are added can be selected based on attributes of the material within the barrel. For example, additives can be added when the material reaches a particular fluidity to ensure that the additives can mix with the material.

Screw 222 can have any suitable channel depth and screw angle for directing material towards die 250. In some cases, screw 222 can define several zones each designed to have different effects on the material in barrel 220. For example, screw 222 can include a feed zone adjacent to the hopper and operative to carry solid material pellets to an adjacent melting zone where the solid material melts. The channel depth can progressively increase in the melting zone. Following the melting zone, a metering zone can be used to melt the last particles of material and mix the material to a uniform temperature and composition. Some screws can then include a decompression zone in which the channel depth increases to relieve pressure within the screw and allow trapped gases (e.g., moisture or air) to be drawn out by vacuum. The screw can then include a second metering zone having a lower channel depth to re-pressurize the fluid material and direct it through the die at a constant and predictable rate.

When fluid material reaches die end 226 of barrel 220, the material can be expelled from barrel 220 and can pass through screen 230 having openings sized to allow the material to flow, but preventing contaminants from passing through the screen. The screen can be reinforced by a breaker plate used to resist the pressure of material pushed towards the die by screw 222. In some cases, screen 230, combined with the breaker plate, can serve to provide back pressure to barrel 220 so that the material can melt and mix uniformly within the barrel. The amount of pressure provided can be adjusted by changing the number of screens used, the relative positions of the screens (e.g., mis-aligning openings in stacked screens), or changing the size of openings in a screen.

The material passing through the screen is directed by feedpipe 240 towards die 250. Feedpipe 240 can define an elongated volume through which material can flow. Unlike in barrel 220, in which material rotates through the barrel, material passing through feedpipe 240 can travel along the axis of the feedpipe with little or no rotation. This can ensure that when the material reaches the die, there are no built-in rotational stresses or strains that can adversely affect the resulting cable structure (e.g., stresses that can cause warping upon cooling).

Fluid material passing through feedpipe 240 can reach die 250, where the material is given a profile corresponding to the final conductor structure. Material can pass around pin 252 and through opening 254 of the die. Pin 252 and opening 254 can have any suitable shape including, for example, circular shapes, curved shapes, polygonal shapes, or arbitrary shapes. In some embodiments, pin 252 can be movable within die 250. In some embodiments, elements of die 250 can move such that the size or shape of opening 254 can vary. Once material has passed through the die, the material can be cooled to maintain the extruded shape. The material can be cooled using different approaches including, for example, liquid baths (e.g., a water bath), air cooling, vacuum cooling, or combinations of these.

FIG. 3 is a flowchart of an illustrative process for extruding a leg of a cable structure in accordance with some embodiments of the invention. Process 300 can begin at step 302. At step 304, silicon polymer-based material to be extruded can be provided to an extruder. For example, pellets of silicon polymer can be placed in a hopper of an extruder. The extruder can melt the material, and apply pressure to the melted material so that it may be directed out of the extruder. At step 306, a conductor bundle can be fed through a die. For example, a bundle that includes conductors and a superelastic rod can be placed within a hypodermal path. Or, for example, a series of four conductors such as those shown in FIG. 1 can be fed through the die.

At step 308, the silicon polymer material can be extruded through the die to surround the conductor bundle, which is also passing through the die. The combination of the extruded material and conductor bundle form an extruded leg. At step 310, system factors of the extruder can be dynamically adjusted to change dimensions of the extruded cable as required to meet performance needs. In particular, the diameter of any extruded cable component can change from a large diameter in an interface region to a variable diameter defining a smooth transition from the large diameter to a small diameter of a non-interface region. Any suitable system factor can be changed including, for example, the position of die components (e.g., the position of the die pin), line speed, heat applied to the extruder, screw rotation speed, melt pressure, and air pressure, or combinations of these. Process 300 can end at step 312.

As described above, when silicon polymer-based material is used for electrical cable jackets, it is desirable to have a flame retardant added to the extrusion material. That material could be added into hopper 210, for example, prior to step 304 occurring. Any other additives would be provided in a similar manner.

Manufacturing of silicon polymer-based cable structures via an extrusion process can provide several advantages. For example, the extrusion process can provide a continuous and smooth structure that is aesthetically pleasing. The silicon polymer-based materials results in cables that remain aesthetically pleasing because they are more resistant to stains and other chemical damage than traditional TPE/TPU elastomer based cable jackets. Moreover, the use of silicon polymer-based cable jackets enables the overall cable dimensions to be reduced because of the improved durability.

The described embodiments of the invention are presented for the purpose of illustration and not of limitation.

What is claimed is:

1. A method for constructing cable jacket structures, the method comprising:
providing silicon polymer-based material to an extruder, the extruder comprising a die through which the material is extruded;
feeding a conductor bundle through a hypodermic path extending through a portion of the die;
extruding the silicon polymer-based material through the die while the conductor bundle is fed through the hypodermic path, wherein the extruded material surrounds the conductor bundle to form a leg; and
dynamically adjusting system factors of the extruder to change the diameter cable jacket based on the dimensions of the cable jacket being formed.

2. The method of claim 1, wherein the system factors comprise at least one of:
a line speed;
heat;
a screw rotation speed;
a melt pressure; and
an air pressure.

3. The method of claim 1, further comprising:
coupling one end of the cable jacket to a bifurcation region, wherein the bifurcation region is coupled to at least two other cable jacket extensions to form a multi-leg cable.

4. A system for extruding cable structures, the system comprising:
a barrel comprising a hopper end and a die end, the barrel operative to heat and melt silicon polymer-based material to extrude, wherein the silicon polymer-based material is deposited into the barrel from the hopper end;
a screw positioned within the barrel, wherein the screw is operative to displace the silicon polymer-based material from the hopper end towards the die end;
a die coupled to the barrel at the die end, the die operative to shape the melted material expelled through an opening in the die end of the barrel to form a cable jacket; and
a control station operative to adjust the operation of the system to dynamically change an outer diameter of the cable jacket as manufacturing requirements vary.

5. The system of claim 4, further comprising:
a hopper operative to receive pellets of a material to extrude, wherein the hopper is coupled to the hopper end of the barrel to direct the pellets from the hopper into the barrel.

6. The system of claim 4, wherein:
the conductor bundle is substantially aligned with a centerline of the cable jacket.

7. The system of claim 4, wherein the control station is further operative to change the outer diameter of the cable jacket by controlling at least one of:
a line speed;
heat;
a screw rotation speed;
a melt pressure; and
an air pressure.

8. The system of claim 4, wherein the control station is further operative to:
adjust the operation of the system to create a split in the cable jacket.

9. A cable comprising:
a plurality of conductors;
a wrap having a first side and a second side, the first side comprising insulating material and the second side comprising conductive material, the first side being wrapped around, and in contact with, the plurality of conductors;
a metal braid that overlays the second side of the wrap; and
a silicon-based cable jacket formed over the metal braid.

10. An extruded silicon polymer-based cable structure, comprising:
a conductive bundle; and
an extruded silicon polymer-based jacket that completely encapsulates the conductive bundle, wherein the silicon polymer-based jacket comprises a silicon polymer-based material and a flame retardant additive.
